(19) United States
(12) Patent Application Publication
(10) Pub. No.: US 2012/0035515 A1
(43) Pub. Date: Feb. 9, 2012

(54) CLAPPING DEVICE FOR EFFECTING CLAPPING FORCE TO A PREDETERMINED AREA OF A BODY

(75) Inventor: Zim Guan NG, Kedah (MY)

(73) Assignee: At Newlife Technologies SDN BHD, Seberang Jaya, Penang (MY)

(21) Appl. No.: 13/263,297

(22) PCT Filed: Apr. 6, 2009
(86) PCT No.: PCT/MY10/00049

§ 371 Date: Oct. 6, 2011

(30) Foreign Application Priority Data
Apr. 6, 2009 (MY) PI20091382

(51) Int. Cl. A61H 23/00

(52) U.S. Cl. 601/107

(57) ABSTRACT

The present invention relates generally to a clapping device for effecting clapping force to the area of contact capable of clearing congested lungs of obstructive mucous secretions as well as performing massaging and muscle relaxing tasks comprising mechanised clappers (20) attached to a main housing (2) to be worn by the user or detachably strapped or clipped over a structure capable of being strapped or clipped or detachably attached to a portable hand-held holder.

### TECHNICAL FIELD OF THE INVENTION

The present invention relates generally to a portable clapping device for effecting clapping force to a predetermined area of the body capable of clearing congested lungs of obstructive mucous secretions as well as performing massaging and muscle relaxing tasks comprising mechanised clappers attached to a main housing to be worn by the person receiving treatment or detachably strapped over a structure capable of being strapped or detachably attached to a portable hand-held holder.

### BACKGROUND OF THE INVENTION

Administering clapping therapy as a traditional physiotherapy to ease congested lungs from obstructive mucous secretions such as phlegm has long been known and used on adults as well as children suffering from pulmonary illnesses such as bronchitis. The clapping therapy performed by traditional physiotherapist is used to clear congested air passages within the lungs to ease breathing in persons having such congestive disorders. Traditionally administering such clapping therapy is by a therapist who will manually deliver a series of blows with the open hand to the area of the body adjacent to the lungs to aid the patient expel obstructive mucous secretions from the air passages in the lungs. However the effectiveness of this form of manual treatment varies from therapist to therapist and also the skill of the therapist. Further the blows effected onto the patient varies according to the strength of the therapist and the duration of the therapy as the force of the therapist's blow may be initially harder but gradually decreases when the therapist becomes tired during the course of the treatment especially if the treatment is for a long duration. Moreover as the configuration of the therapist's palm is not constant the area where force is applied varies. All these result in inconsistencies. Problems also arise where the therapist is not be able to estimate the degree of force to effect on a young child and may therefore exert more force than required, such force may exceed the safety and comfort limit.

Consequently attempts have been made to address the above shortcoming by providing standard sized clappers which are hand-held by the therapists to overcome inconsistencies of the therapist's palm. Then motorized or automated devices designed to circumvent problems associated with subjectivity due to the human factor was introduced for greater efficiency wherein a mechanized device is employed for use in clapping treatment capable of providing a constant standard clapping force to a pre-determined area of a patient's body adjacent to the lungs at a frequency that is adjustable thus overcoming inconsistencies associated to humans or that due to physical strain on the therapist as the treatment course continues. Usually such treatment is only available upon appointment and in a hospital or clinic which may pose a hassle and discourage a patient from seeking such treatment and a patient would not be able to enjoy such treatment in the comfort of his home or as and when he is free or as frequently as he desires.

It would hence be extremely advantageous, convenient and cost saving if the said clapping device is not fixed permanently to any structure but is portable and able to be carried, hand-held or worn over the shoulder, (wearing it like a jacket or backpack or vest) or strapped over a structure capable of being strapped so that the patient, children or adults, young or old, can enjoy such clapping treatment anytime anywhere hassle free. It is therefore an aim of the invention to provide such a portable clapping device that not only treats congestive lung disorders but is also able to provide massaging and muscle relaxing functions.

### SUMMARY OF THE INVENTION

Accordingly, it is the primary aim of the present invention to provide a portable clapping device which is convenient and hassle-free as the clapping treatment can be used anywhere anytime whether the person is stationary or mobile.

It is yet another object of the present invention to provide a portable clapping device wherein precious time is saved in not having to travel to another place to seek treatment.

It is yet another object of the present invention to provide a clapping device wherein the tempo, frequency, speed and force of the clapper is adjustable to suit different user needs.

It is yet another object of the present invention to provide a portable clapping device which is simple and easy to use.

It is yet another object of the present invention to provide a portable clapping device which affords flexibility as it can either be worn, hand held or even fixed.

It is yet another object of the present invention to provide a portable clapping device wherein the clapper member is easily replaceable with a new one due to wear and tear or with attractive designs to encourage children to allow usage of the clapping device on them.

It is yet another object of the present invention to provide a portable clapping device which has several functions such as to clear obstructive mucous secretions, to act as a massager, to act as a muscle relaxant and to abate continuous hiccups.

Other and further objects of the invention will become apparent with an understanding of the following detailed description of the invention or upon employment of the invention in practice.

According to a preferred embodiment of the present invention there is provided,

A clapping device (4) for effecting clapping force to a pre-determined area of a person's body comprising;
at least a clapper member (20),
at least a reciprocation mechanism (32) connected to said clapper member (20) for controlling reciprocating motion of the said clapper member (20),
characterised in that,
the said reciprocation mechanism (32) utilizes at least a clapping force generating element (36) to actuate at least a clapper member (20) into a to and fro mode,
the said reciprocation mechanism is housed in a reciprocation mechanism housing (25) and in turn mounted to a portable main housing (2).

In implementing the above preferred embodiment there is provided,

A method of generating clapping force to a pre-determined area of a person's body comprising steps of,
putting on a portable main housing (2) over a person or a structure,
activating a reciprocation mechanism (32) causing rotation of a clapping force generating element (36) which is connected to a shaft (26) driven by a drive motor (27),
causing the contacting of said clapping force generating element (36) with at least a support bar provided with at least a clapper member (20) at its end to actuate support bar,
causing at least a clapper member (20) to move in a to and fro mode.

### BRIEF DESCRIPTION OF THE DRAWINGS

Other aspect of the present invention and their advantages will be discerned after studying the Detailed Description in conjunction with the accompanying drawings in which:

FIGS. 1-A and 1-B show the respective side and rear view of a person wearing a portable clapping device of the present invention capable of effecting clapping force to a pre-determined area of a person's body.

FIG. 2 shows a perspective view of the main housing in isolation.

FIG. 3 shows a cross-sectional view along line A-A of the main housing shown in FIG. 2.

FIGS. 4-A, 4-B and 4-C show several views of a first embodiment of the reciprocation mechanism employed in the said clapping device to actuate the clapper members to produce desired clapping force prior to being mounted on the main housing.

FIGS. 5-A, 5-B and 5-C show several views of a second embodiment of the reciprocation mechanism employed in the said clapping device to actuate the clapper members to produce desired clapping force prior to being mounted on the main housing.

FIGS. 6-A, 6-B and 6-C show several views of a third embodiment of the reciprocation mechanism employed in the said clapping device to actuate the clapper members to produce desired clapping force prior to being mounted on the main housing.

FIGS. 7-A, 7-B, 7-C and 7-D show several views of a fourth embodiment of the reciprocation mechanism employed in the said clapping device to actuate the clapper members to produce desired clapping force prior to being mounted on the main housing.

FIGS. 8-A, 8-B, 8-C and 8-D show several views of a fifth embodiment of the reciprocation mechanism employed in the said clapping device to actuate the clapper members to produce desired clapping force prior to being mounted on the main housing.

FIGS. 9-A, 9-B, 9-C, 9-D and 9-E show several views of a sixth embodiment of the reciprocation mechanism employed in the said clapping device to actuate the clapper members to produce desired clapping force prior to being mounted on the main housing.

FIG. 10 is a fragmentary view of the reciprocation mechanism housing being mounted onto the portable main housing.

FIG. 10-A is a fragmentary cross sectional view of the main housing being provided with a reciprocation mechanism housing showing the gear in contact with the tooth-like configuration of the longitudinal slot of the central vertical portion.

FIG. 11-A are several views of the reciprocation mechanism housing prior to and after being mounted onto a chair.

FIG. 11-B are several views of the reciprocation mechanism housing prior to and after being clipped onto a chair.

FIG. 12 is an isometric view of the reciprocation mechanism housing being mounted onto a holder.

### DETAILED DESCRIPTION OF THE DRAWINGS

In the following detailed description, numerous specific details are set forth in order to provide a thorough understanding of the invention. However, it will be understood by those of ordinary skill in the art that the invention may be practised without these specific details. In other instances, well known methods, procedures and/or components have not been described in detail so as not to obscure the invention.

The invention will be more clearly understood from the following description of the embodiments thereof, given by way of example only with reference to the accompanying drawings, which are not drawn to scale.

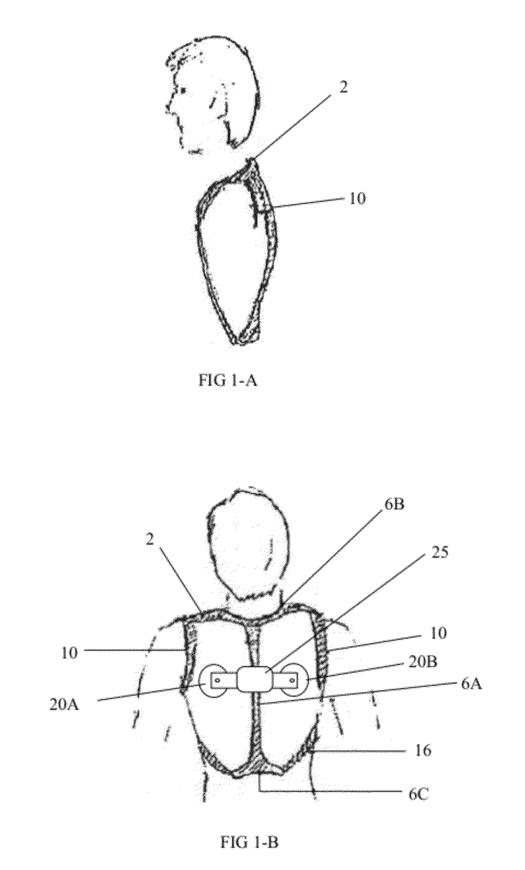

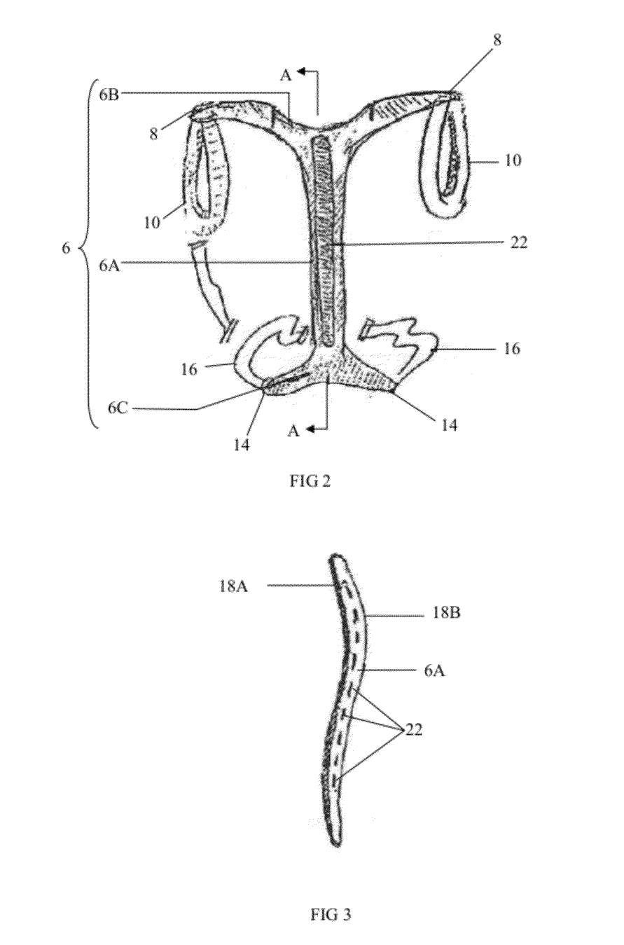

Referring to FIGS. 1-A, 1-B, 2 and 3, there are shown the respective side and rear view of a person wearing a portable clapping device of the present invention capable of effecting clapping force to a pre-determined area of a person's body, a perspective view of the main housing (2) in isolation and a cross-sectional view along line A-A of the main housing (2) shown in FIG. 2. As illustrated, the main housing (2) comprises a rigid portion (6) made of preferably plastics, which has a configuration that is substantially similar to the letter “T”. The said rigid portion (6) consists of a central vertical portion (6A), which is similar to a human vertebrate, a top portion (6B), which is substantially horizontal in relation to the central vertical portion (6A) and a bottom portion (6C), which is also substantially horizontal in relation to the central vertical portion (6A). The said top portion (6B) is preferably longer than the bottom portion (6B) and is configured to follow the shape of the human shoulder whilst the bottom portion (6C) is configured to preferably follow the shape of the human waist. The top portion (6B) has two opposing end portions, hereinafter called top end portions (8). Each top end portion (8) is located furthest from the central vertical portion (6A) and is provided with arm straps (10) so that the top portion (6B) of the main housing (2) can be secured to the shoulder portion. Preferably the arm straps (10) are made of fabric but other kinds of materials are possible as long as they are soft to allow comfort to the user. The bottom portion (6B) similarly has two opposing end portions, hereinafter called bottom end portions (14). Each bottom end portion (14) is also located furthest from the central vertical portion (6A) and is provided with waist straps (16) to be tied to the waist to further secure the main housing (2) to the body. Preferably the waist straps (16) are made of fabric but other kinds of materials are possible as long as they are soft to allow comfort to the user. The central vertical portion (6A) is preferably provided with cushiony material at the inner part (18A) of the central vertical portion (6A) which comes into contact with the human body for comfort and to absorb the impact of the constant blows exerted by the clapper members (20). The outer part (18B) of the central vertical portion (6A) which is exposed when the main housing (2) is worn has at least a perforation (22) preferably a longitudinal slot along the central vertical portion (6A) to enable a reciprocation mechanism housing (25) to be detachably attached by means of an attaching means such as a clip. The reciprocation mechanism housing (25) houses a reciprocation mechanism (32) which is made up of a clapping force generating element (36) preferably a cam connected to a shaft (26), a drive motor (27) and at least a clapper member (20) attached to at least a support bar. The drive motor (27) is powered at a low speed to create a low frequency rotary movement to turn the clapping force generating element (36).

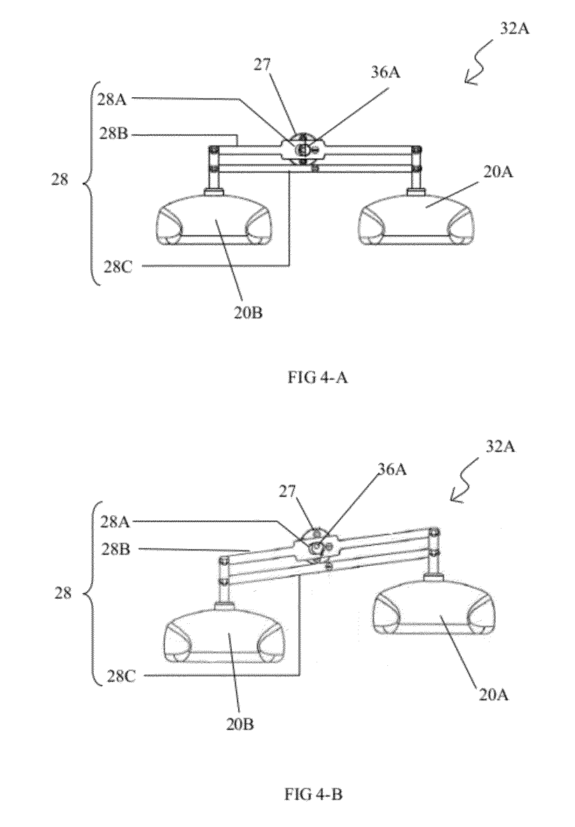

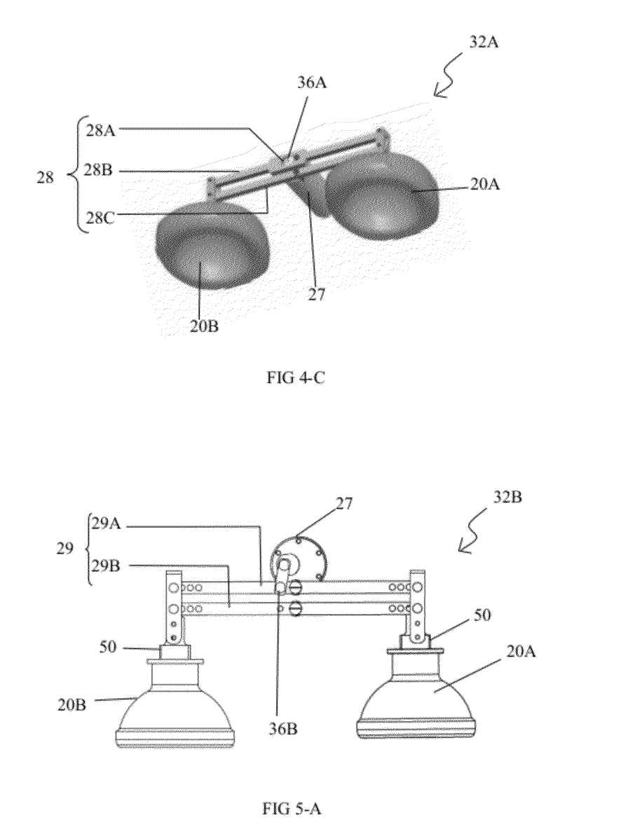

The clapping force is generated by means of a reciprocation mechanism (32) generally comprising of at least a clapping force generating element (36) connected to a shaft driven by a drive motor (27) to act on at least a support bar with at least a clapper member (20) attached to its free end to create pre-determined to and fro clapping force. The reciprocation mechanism (32) may be of several embodiments as illustrated in FIGS. 4, 5, 6, 7, 8 and 9. FIGS. 4-A and 4-B respectively illustrate views of a first embodiment of the reciprocation mechanism which may be employed in the said clapping device to actuate the clapper members (20) to produce desired clapping force prior to and after activation while FIG. 4-C is a bottom perspective view of the said first embodiment. The reciprocation mechanism illustrated in FIGS. 4-A, 4-B and 4-C shall be referred to as the first reciprocation mechanism and hereafter be indicated by the reference numeral (32A). The first reciprocation mechanism (32A) comprises at least a first clapping force generating element (36A) preferably a cam connected to a shaft (not shown) to be rotably driven by a drive motor (27) to contact an aperture (28A) substantially situated at the central axis of an elongated support bar (28B) [having its ends provided with clapper members (20)]. When the first reciprocation mechanism (32A) is activated, the motor (27) will rotate the said first clapping force generating element (36A) so that its side comes into contact with the periphery of the said aperture (28A) thereby pushing against the support bar (28B) which in turn tilts (shifts) the support bar (28B) from its original non-activated position [original non-activated position here is defined as the position of the support bar (28) and clapper member (20) when the first reciprocation mechanism (32A) is not activated as shown in FIG. 4-A]. The above accordingly causes one of the clapper member (20) for example the first clapper member (20A) which is pivotably attached to the support bar (28B) to move from its original position whilst the other clapper member (20) for example the second clapper member (20B) remains at its original position. In short one clapper member (20) will be in contact with a pre-determined area of a person's body whilst the other clapper member (20) is moved away from the person's body. Further continuous rotation of the first clapping force generating element (36A) within the aperture (28A) causes the second clapper member (20B) to shift or move from its original position whilst the first clapper member (20A) returns to its original position. This completes the rotation of one cycle. As the clapping force generating element (36A) is continuously rotated, the cycle is repeated resulting in a to and fro movement preferably an alternate movement of the first and second clapper members (20A) (20B) towards the body area. This to and fro movement therefore results in an alternating left and right clapping force to be effected to a desired body area of a person capable of generating resonance waves to amongst others loosen congested lungs. It is to be understood that the to and fro movement includes any oscillating movement, up and down movement or a forward and backward movement or a left and right movement. A second support bar (28C) pivotably attached to the clapper member (20) is preferably provided parallel to the first support bar (28B) so that the mouth of the clapper member (20) can be firmly held in a downwardly direction to contact the body area. The second support bar (28C) will move in tandem with the first support bar (28A). The first and second support bars (28B) (28C) illustrated in the said figures is generally referred to by the reference numeral (28) and FIGS. 4-A, 4-B and 4-C are collectively referred to as FIG. 4.

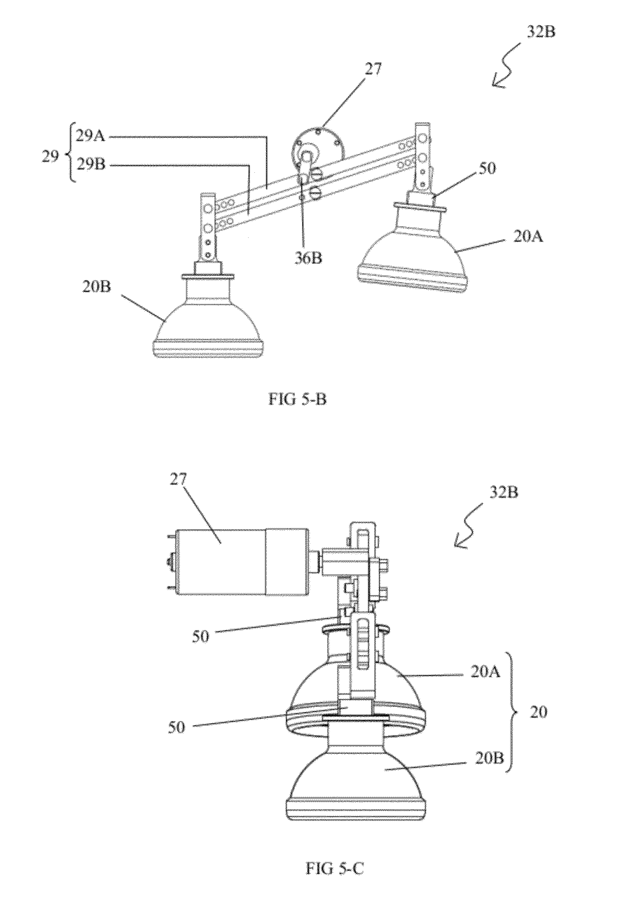

Referring now to FIGS. 5-A, 5-B and 5-C, (hereinafter collectively referred to as FIG. 5) several views of a second embodiment of the reciprocation mechanism employed in the said clapping device to actuate the clapper members (20) to produce desired clapping force is illustrated. The reciprocation mechanism of illustrated in FIG. 5 shall be referred to as the second reciprocation mechanism and hereafter be indicated by the reference numeral (32B). The second reciprocation mechanism (32B) comprises at least a second clapping force generating element (36B) preferably a cam which works in a similar manner as that in FIG. 4 except that the second clapping force generating element (36B) is attached to a first elongated support bar (29A) and moves in a circular motion which will tilt the first support bar (29A) up and down to alternately actuate the first and second clapper member (20A) (20B) towards the body area. The second clapping force generating element (36B) of this second reciprocation mechanism (32B) is created to evenly distribute the force between the two clapper members (20) which are pivotably attached to the support bar (29) so that the force effected by the clapper member (20) on the body is substantially uniform and constant. A second support bar (29B) is preferably provided parallel to the first support bar (29A) attached to the second clapping force generating element (36B) so that the mouth of the clapper member (20) can be firmly held in a downwardly direction. The second support bar (29B) will move in tandem with the first support bar (29A). The first and second support bars (29A) (29B) illustrated in the said figures are generally referred to by the reference numeral (29). Preferably a body fitter or adjustor (50) is provided to each clapper member (20) to allow flexibility in movement to cater for the uneven contours of a person's body surface.

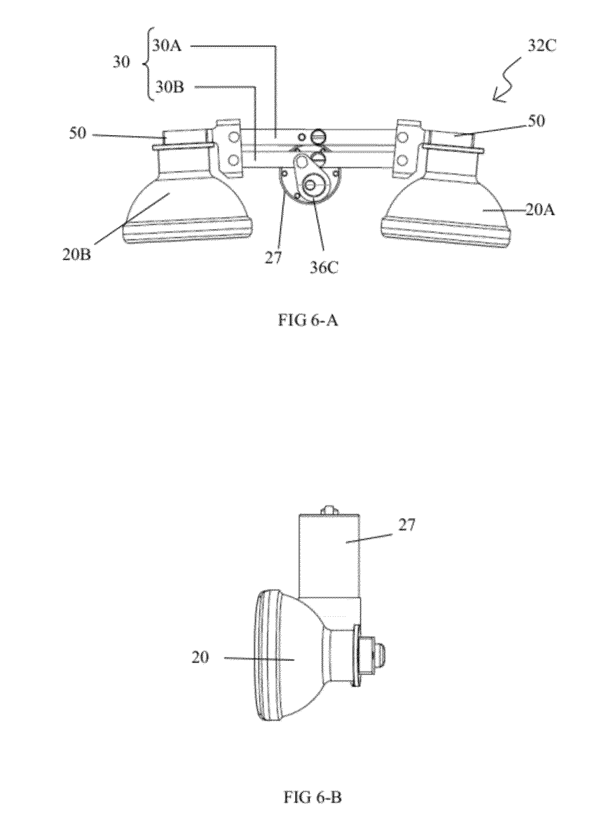

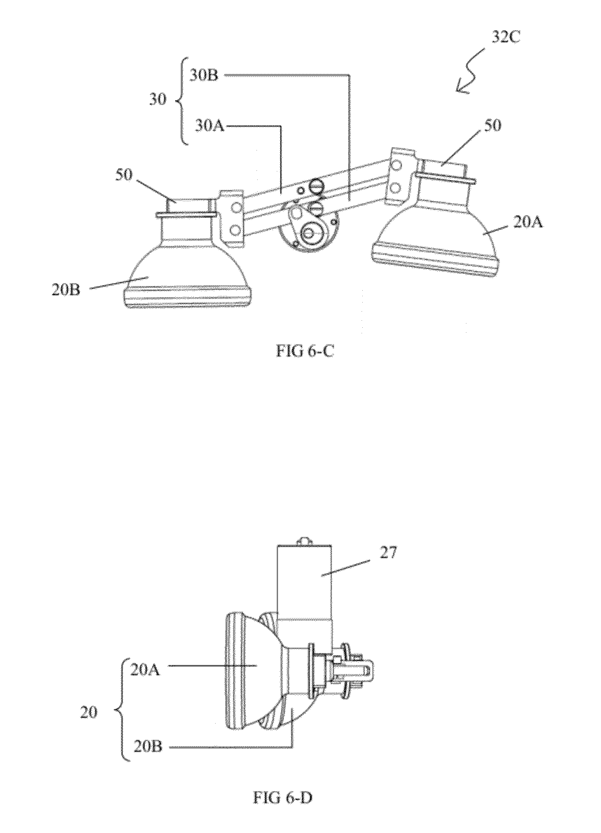

Referring now to FIGS. 6-A, 6-B and 6-C (hereinafter collectively referred to as FIG. 6), there are shown several views of a third embodiment of the reciprocation mechanism employed in the said clapping device to actuate the clapper members (20) to produce desired clapping force prior to being mounted on the main housing. The reciprocation mechanism illustrated in FIG. 5 shall be referred to as the third reciprocation mechanism and hereafter be indicated by the reference numeral (32C). The third reciprocation mechanism (32C) is substantially similar to the second reciprocation mechanism (32B) shown in FIG. 5 save for the positioning of the third clapping force generating element (36C) preferably a cam which is being attached to the second support bar (30B) instead of the first support bar (30A) and the employment of another embodiment of body fitter or adjustor (50) which allows the clapper members (20) and support bars to be in substantial horizontal alignment. A second support bar (30B) is also provided. The first and second support bars (30A) (30B) illustrated in the said figures are generally referred to by the reference numeral (30). The method of generating clapping force is similar to that generated in the second reciprocation mechanism (32B).

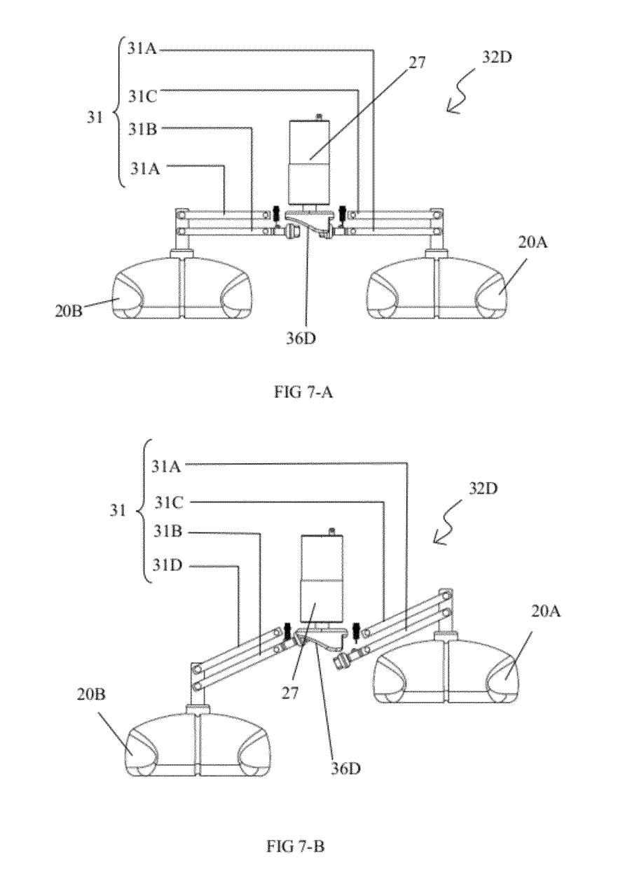

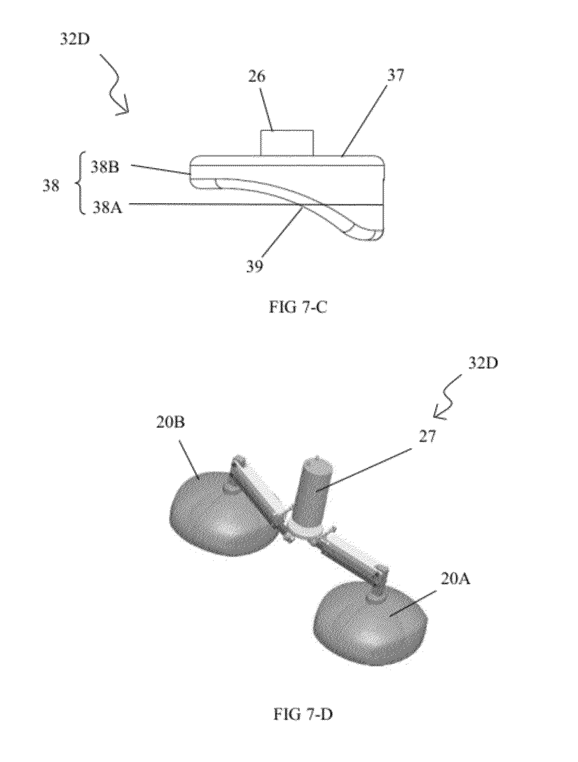

Referring now to FIGS. 7-A, 7-B, 7-C and 7-D (hereinafter collectively referred to as FIG. 7), several views of a fourth embodiment of the reciprocation mechanism employed in the said clapping device to actuate the clapper members (20) to produce desired clapping force is illustrated. The reciprocation mechanism of illustrated in FIG. 7 shall be referred to as the fourth reciprocation mechanism and hereafter be indicated by the reference numeral (32D). As illustrated in FIG. 7-C, which is an enlarged fourth clapping force generating element (36D), the said clapping force generating element (36D) is provided with a special configuration which has a flat portion (37), cylindrical side (38) and a sloped portion (39) opposing the flat portion (37) such that the cylindrical side has a wide side portion (38A) and a narrow side portion (38B), said wide and narrow side portions (38A) (38B) are opposing each other to form a lopped-sided clapping force generating element (36D). The flat portion (37) is connected to a shaft and driven by a motor (27) whilst the peripheral sloped portion (39) comes into contact with at least a support bar (31). The support bars illustrated in this figure are generally referred to by the reference numeral (31). Preferably a pair of support bar, that is a first support (31A) and a second support bar (31B) pivotably provided with a clapper member (20) on each end are employed in generating clapping force, however it is to be appreciated that at least one support bar (31) attached with one clapper member (20) will work as well as what is advantageous is that the present invention is capable of generating clapping force at a desired tempo, frequency and speed. In a similar manner as in FIG. 4-B, when the fourth reciprocation mechanism (32D) preferably a cam is activated, the motor (27) will rotate the said lopped sided fourth clapping force generating element (36D) so that the periphery of the wide portion (38A) of the lopped sided fourth clapping force generating element (36D) comes into contact with the first support bar (31A) as shown in FIG. 7-B. Simultaneously when the wide side portion (38A) is in contact with the first support bar (31A) to depress its end nearer the fourth clapping force generating element (36D) to in turn tilt (shift) the other end of the first support bar (31A) attached with the clapper member (20) from its original non-activated position [original non-activated position is the position of the support bar (31) and clapper member (20) when the fourth reciprocation mechanism (32D) is not activated as shown in FIG. 7-A], the narrow side portion (38B) which will almost but not be in contact with the other support bar (31), that is the second support bar (31B), is maintained in its original position. As there is no contact between the narrow side portion (38B) with the second support bar (31B) hence no tilting movement of the second support bar (31B) is effected. The contact of the periphery of the wide portion (38A) with the first support bar (31A) accordingly causes the first clapper member (20A) to move from its original position whilst the second clapper member (20B) remains in its original position. In short at any one time one clapper member (20) will be in contact with a pre-determined area of a person's body whilst the other clapper member (20) is moved away form the person's body. Further continuous rotation of the lopped-sided fourth clapping force generating element (36D) causes the edge of the wide side portion (38A) to move away from the first support bar (31A) and eventually to come into contact with the second support bar (31B) whilst the edge of the narrow side (38B) is caused to move away from the second support bar (31B) toward the first support bar (31A) causing the second clapper member (20B) to move from its original position [in a similar manner as described above for the first clapper member (20)] whilst the first clapper member (20A) returns to its original position. This completes the rotation of one cycle. The said wide and narrow side portions (38A) (38B) which are opposing each other alternately comes into contact and close proximity respectively with the first and second support bars (31A) (31B) respectively when the said fourth clapping force generating element (36D) is rotably driven by a motor (27). As the fourth clapping force generating element (36D) is continuously rotated the cycle is repeated resulting in a to and fro movement preferably an alternate movement of the first and second clapper members (20A) (20B) towards the body area. This to and fro movement results in an alternating left and right clapping force to be effected to a desired body area of a person capable of generating resonance waves to amongst others loosen congested lungs. The to and fro movement may include any oscillating movement or up and down movement or forward and backward movement or left and right movement. A third and fourth support bar (31C) (31D) are preferably provided parallel to the first and second support bar (31A) (31B) and their ends are attached to the clapper member (20) so that the mouth of the clapper member (20) can be firmly held in a downwardly direction. The third and fourth support bar (31C) (31D) will move in tandem with the first and second support bar (31A) (31B). Preferably at least a springing element (40) is provided to the clapping device to assist in gradually pulling or retracting the first or second support bars (31A) (31B), as the case may be, to its original position as the fourth clapping force generating element (36D) rotates towards the narrow side portion (38B). When the wide side portion (38B) of the fourth clapping force generating element (36D) rotates to contact the first or second support bars (31A) (31B), as the case may be, the springing element (40) will accordingly extend gradually and offers some movement control so that sudden tilting or movement of the support bar (31) will not arise.

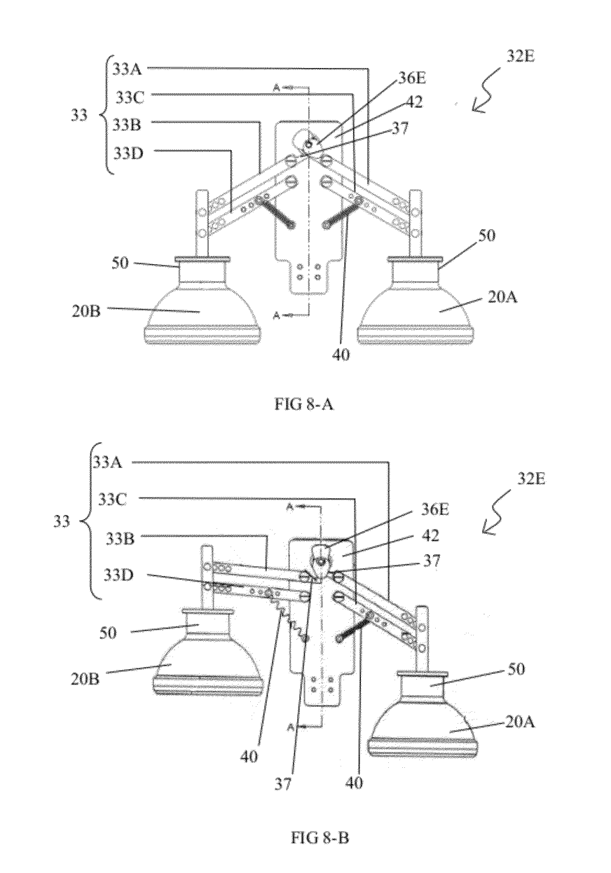

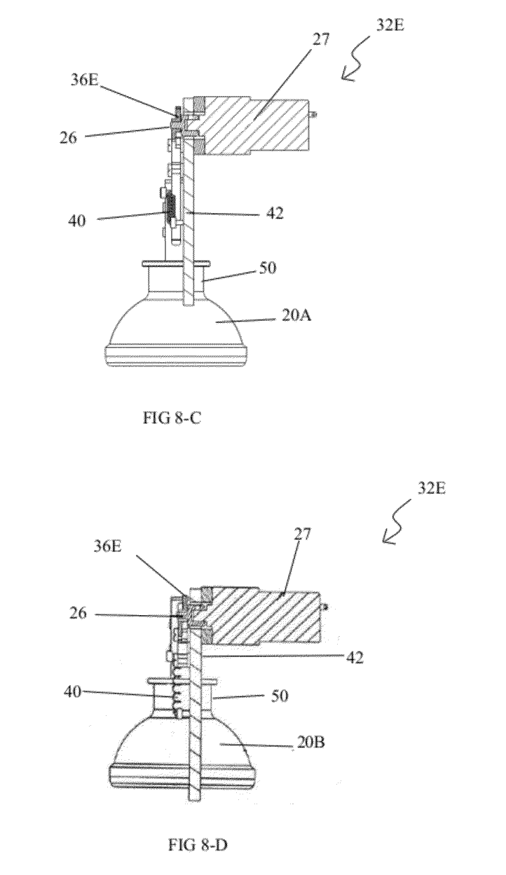

Referring now to FIGS. 8-A, 8-B, 8-C and 8-D (hereinafter collectively referred to as FIG. 8), several views of a fifth embodiment of the reciprocation mechanism is employed in the said clapping device to actuate the clapper members (20) to produce desired clapping force is illustrated. The reciprocation mechanism illustrated in FIG. 8 shall be referred to as the fifth reciprocation mechanism and hereafter be indicated by the reference numeral (32E). The reciprocation mechanism (32E) comprises a plate (42) on which is an opening to accommodate a fifth clapping force generating element (36E), preferably a cam, connected to a shaft and driven by a drive motor (27). On the said plate (42) are pivotably mounted support bars (33) provided with clapper members (20) and the said bars (33) are held in place by at least a springing element (40) preferably a helical spring. Preferably each side of the plate (42) has two support bars, a first support bar (33A) and a second support bar (33B) linking the support plate (42) and the clapper member (20). The first bar (33A) has a protrusion (37) that will contact the fifth clapping force generating element (36E). The fifth clapping force generating element (36E) consists of preferably two cams in overlapping arrangement. When the fifth reciprocation mechanism (32E) is activated the fifth clapping force generating element (36E) is rotably driven by a drive motor (27) to enable a first cam to contact with a protrusion (37) of the first support bar (33A) thereby depressing it which in turn tilts (shifts) the first support bar (33A) from its original non-activated position [original position is the position of the support bar (33) and clapper member (20) when the fifth reciprocation mechanism (32E) is not activated as shown in FIG. 8-A]. The support bars illustrated in the said figures are generally referred to by the reference numeral (33). The above accordingly causes the first clapper member (20A) pivotably attached to the support bar (33) to move from its original position whilst the second clapper member (20B) is maintained at its original position. In short at any one time one clapper member (20) will be in contact with a pre-determined area of a person's body whilst the other clapper member (20) is moved away form the person's body. Further continuous rotation of the fifth clapping force generating element (36E) will cause the second cam to contact the protrusion (37) of the second support bar (33B) thereby depressing it which in turn tilts (shifts) the second support bar (33B) from its original position. The above causes the second clapper member (20B) pivotably attached to the support bar (33) to move from its original position away from the body area whilst the first clapper member (20A) returns to its original position. This completes the rotation of one cycle. As the fifth clapping force generating element (36E) is continuously rotated the cycle is repeated resulting in a to and fro movement of the support bar (33) and accordingly the clapper member (20). This to and fro movement results in an alternating left and right clapping force to be effected to a desired body area of a person capable of generating resonance waves to amongst others loosen congested lungs. The to and fro movement may include any oscillating movement or up and down movement or forward and backward movement or left and right movement. A third and fourth support bars (33C) (33D) are preferably provided parallel to the first and second support bars (33A) (33B) attached to the clapper member (20) so that the mouth of the clapper member (20) can be firmly held in a downwardly direction to contact the body area. The third and fourth support bars (33C) (33D) will move in tandem with the first and second support bars (33A) (33B). Preferably at least a springing element (40) is provided to the support bar to assist in pulling or retracting the support bars (33A) (33B) to its original position as the fifth clapping force generating element (36E) rotates further after actuating the support bars (33). When the fifth clapping force generating element (36E) rotates to the position enabling it to actuate the support bar (33) the springing element (40) will accordingly extend and this offers some movement control so that sudden tilting or movement of the support bar (33) will not arise.

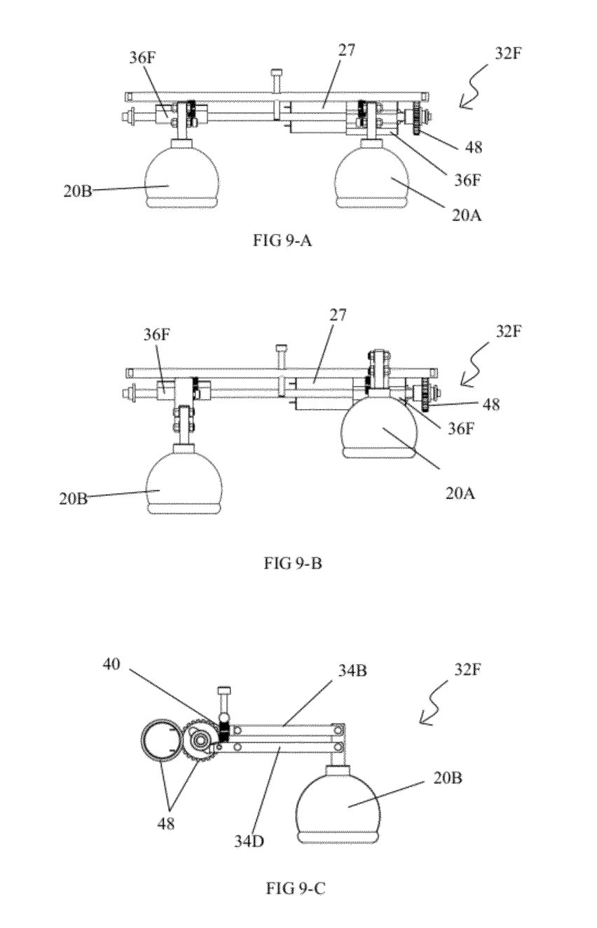

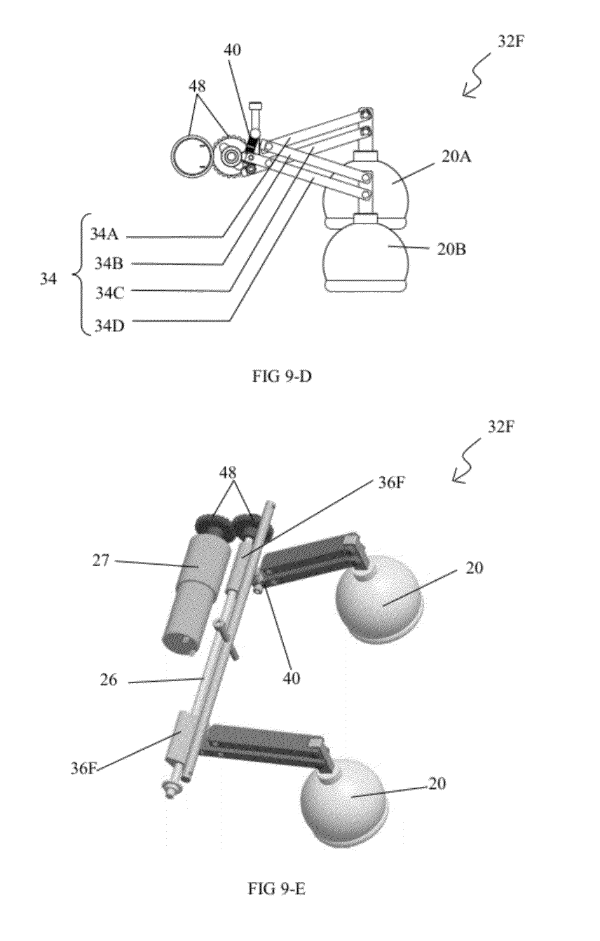

Referring now to FIGS. 9-A, 9-B, 9-C, 9-D and 9-E (hereinafter collectively referred to as FIG. 9), several views of a sixth embodiment of the reciprocation mechanism is employed in the said clapping device to actuate the clapper members (20) to produce desired clapping force is illustrated. The reciprocation mechanism illustrated in FIGS. 9 shall be referred to as the sixth reciprocation mechanism and hereafter be indicated by the reference numeral (32F). This embodiment is provided with a gear component (48) to reduce the speed generated by the drive motor (27) and is advantageous if one is using a high powered drive motor but does not require that much clapping force to be produced. It can be used to reduce the clapping force for various needs as different people have differing needs, some requiring a mild clapping force to be effected in cases of young children and some requiring more forceful clapping force to be effected as in adults. In this sixth reciprocation mechanism (32F) a pair of sixth clapping force generating element (36F) preferably cams are employed, each clapping force generating element (36F) to actuate each clapper member (20). The said pair of sixth clapping force generating element (36F) are connected by an elongated shaft (26) and driven by a drive motor (27) provided with a gear component (48) to reduce or control the speed of the drive motor (27). The clapping force generating element (36F) is arranged in such a manner that when the drive motor is activated, the shaft (26) rotates one of the clapping force generating element (36F) to actuate the first support bar (34A) pivotably attached to the first clapper member (20A) causing it to shift or tilt from its original non-activated position [original non-activated position means the position of the support bar (34) and clapper member when the sixth reciprocation mechanism (32F) is not activated as shown in FIG. 9-A] and accordingly raises the first clapper member (20A) from the body area whilst the other clapping force generating element (36F) does not actuate the other support bar, the second support bar (34B) attached to the second clapper member (20B), and thus the second clapper member (20B) remains in its original position. The support bars (34) illustrated in the said figures are generally referred to by the reference numeral (34). Hence at any one time one clapper member (20) will be in contact with a pre-determined area of a person's body whilst the other clapper member (20) is moved away form the person's body. Further continuous rotation of the shaft (26) will cause the sixth clapping force generating element (36F) to actuate the second support bar (34B) pivotably attached to the second clapper member (20B) causing it to shift or tilt from its original position and accordingly raises the second clapper member (20B) from the body area whilst the clapping force generating element (36F) does not actuate the first support bar (34A) attached to the first clapper member (20A) and thus the first clapper member (20A) is brought back to its original position. This completes the rotation of one cycle. As the clapping force generating element (36F) is continuously rotated the cycle is repeated resulting in a to and fro movement preferably alternate movement of the first and second clapper members (20A) (20B) towards the body area. This to and fro movement results in an alternating left and right clapping force to be effected to a desired body area of a person capable of generating resonance waves to amongst others loosen congested lungs. The to and fro movement includes any oscillating movement or up and down movement or forward and backward movement or left and right movement. A third and fourth support bar (34C) (34D) are preferably provided parallel to the first and second support bar (34A) (34B) attached to the clapper members (20) so that the mouth of the clapper member (20) can be firmly held in a downwardly direction facilitating contact to the body area. The third and fourth support bar (34C) (34D) will move in tandem with the first and second support bar (34A) (34B). Preferably at least a springing element (40) such as a helical spring is provided to the clapping device to assist in pulling or retracting the relevant support bar (34) to its original position as the sixth clapping force generating element (36F) rotates further after actuating one of the support bar (34). When the clapping force generating element (36F) rotates to the position enabling it to actuate the relevant support bar (34) the springing element (40) will accordingly extend and this offers some movement control so that sudden tilting or movement of the relevant support bar (34) will not arise.

The above invention employing the clapping force generating element (36) to actuate the support bar and in turn the clapper members (20) as the reciprocation mechanism (32) causes the clapper members (20) to effect a to and fro movement such as an alternate up-down clapping mode, simulating the clapping action normally provided by the hands of the therapist, to the area of body requiring treatment.

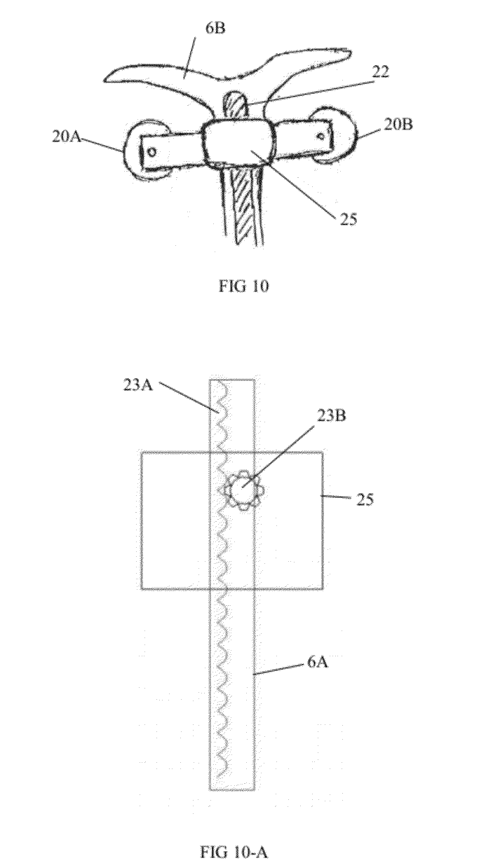

FIG. 10 is an isometric view of the reciprocation mechanism housing (25) being mounted onto the portable main housing (2). Preferably each end of the said support bar is pivotably attached to at least one clapper member (20). The reciprocation mechanism (32) is preferably housed in a reciprocation mechanism housing (25) for detachable attachment to the said main housing (2) by means of slotting the said reciprocation mechanism housing (25) within the perforation (22) [refer to FIG. 3] located on the outer side (18B) of the central vertical portion (6A) of the main housing (2) and secured by an attaching means such as a clip. As a plurality of slots (22) are provided on the central vertical portion (6A) of the main housing (2) the reciprocation mechanism housing (25) can be slotted at any one of the slots (22) so that the clapper members (20) can be adjusted to cater for differing heights of the user. Alternatively the central vertical portion (6A) may be provided with a longitudinal slot having protrusions and depressions depicting tooth-like configuration (23A) which is arranged to complementarily contact with a gear (23B) located in the reciprocation mechanism housing (25) when the reciprocation mechanism housing (25) is attached to the longitudinal slot of the central vertical portion (6A) which enables the reciprocation mechanism housing (25) to move up and down along the longitudinal axis of the main housing (2). This is illustrated in FIG. 10-A which is a fragmentary cross sectional view of the main housing (2) being provided with a reciprocation mechanism housing (25) showing the gear (23B) in contact with the tooth-like configuration (23A) of the longitudinal slot of the central vertical portion (6A). To electronically operate the gear, the gear (23B) is connected to a motor which may be the same reciprocation mechanism motor (27) or another motor. When the motor is activated, it will spin thereby triggering the gear (23A) to rotate along the tooth-like configuration (23A) of the longitudinal slot which in turn electronically moves the reciprocation mechanism housing (25) either up or down as desired. In absence of a motor, the reciprocation mechanism housing (25) can be moved up and down manually along the longitudinal axis.

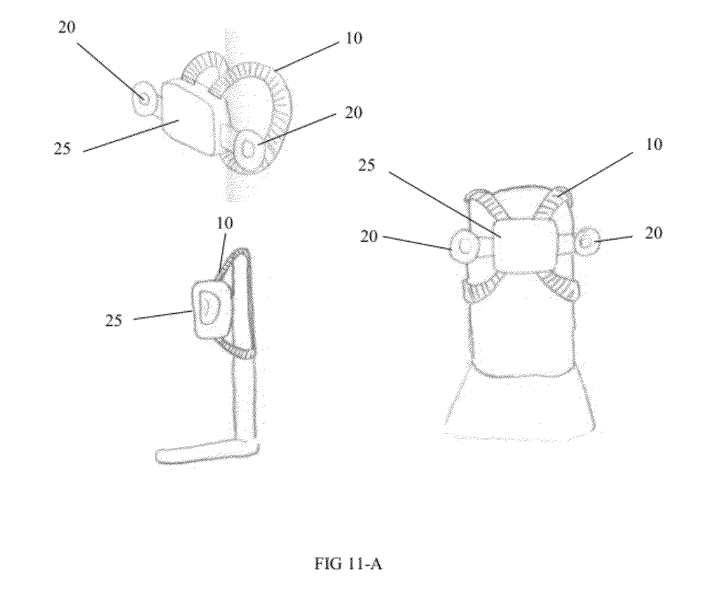

The portability of the main housing (2) has enabled the clapping device to be easily carried around and used as and when required by either putting on or strapping over the user's body preferably over the shoulder or to detachably mount, clip or hang onto a structure such as a chair or bed. FIG. 11-A shows several views of the reciprocation mechanism housing (25) prior to and after being mounted onto a chair. In the case where the clapping device is to be mounted onto a chair, arm straps (10) are provided to the reciprocation housing (25) and the arm straps (10) are strapped on to the back rest of the chair as shown in the said figure. In the case where the clapping device is to be clipped onto a chair, a clip (10A) is being provided to the reciprocation housing (25). The clip (10A) has a hinging means (10B) which preferably divides the clip into two flap portions that are moveable and is capable of locking when the two flap portions are brought to contact with the back rest of the chair as shown in FIG. 11-B or any other portion of a structure to be clipped.

Although the clapping device has been described and illustrated as being strapped onto a body or mounted or clipped onto a structure, this is not necessary so as the clapping device can be incorporated into a special vest or jacket to be worn over the shoulder.

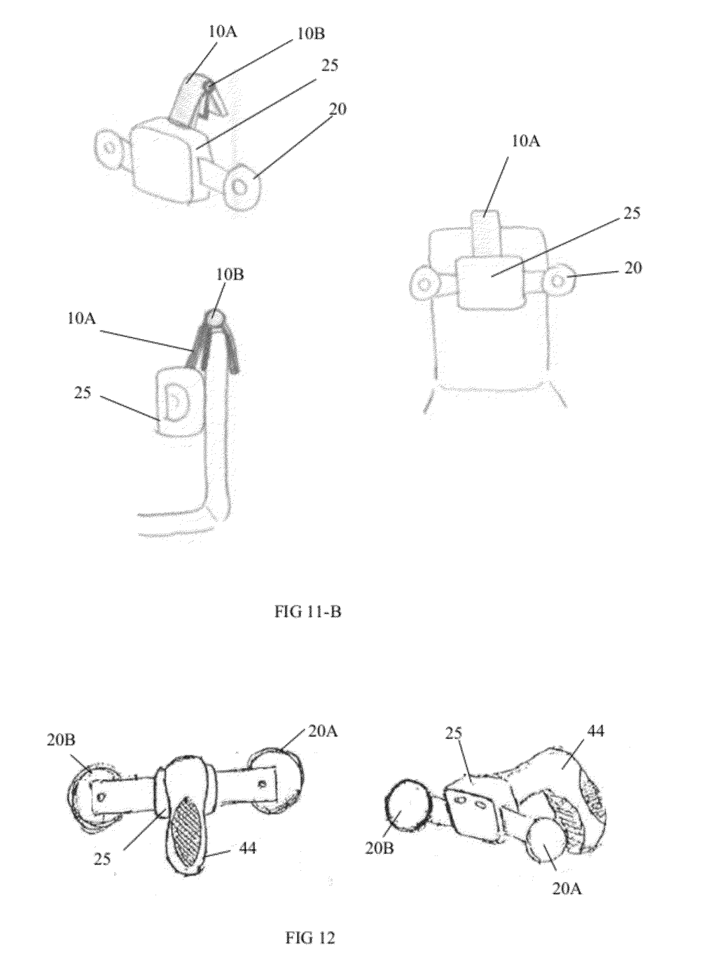

For convenience or when required as in the case of children refusing to have the main housing (2) strapped onto them, the reciprocation mechanism housing (25) can instead of being detachably attached to the main housing (2) be detachably attached to a holder (44) as shown in FIG. 12 which is an isometric view of the reciprocation mechanism housing (25) being mounted onto a holder (44). The mother of the child can then hold the said clapping device over the area of the body requiring treatment.

The clapper members (20) are preferably made to simulate the capped palms of a human. The clapper members (20) are preferably provided with pre-determined perforations to control the compressed air within the clapper members (20) to control the impact of the blow. The clapper members (20) are also easily replaceable due to wear and tear or replaceable with attractive designs to encourage children to allow usage of the clapping device on them. Preferably the clapper member (20) described above is provided with a body fitter or adjustor (50) before being pivotably attached to the support bar to allow flexibility in movement to cater for the uneven contours of a person's body surface. The body fitter is not limited to only the type shown in FIG. 4-A or 5-A but may be of other types or take other configurations as long as it is able to allow flexibility in movement to cater for the uneven contours of a person's body surface.

While the springing element (40) been described and illustrated in some detail as being a helical spring, they are not necessarily the only kind of springs to be used, as long as the other types of springs or springing elements that afford characteristics of being resilient after being compressed or extended may be applicable. Usage of more than one springing element (40) is also possible as what is advantageous is that the present clapping device, utilizing a reciprocation mechanism to actuate the clapper members (20) to produce to and fro clapping force, is portable.

Although the clapping force generating element (36) has been described and illustrated as being a cam, it is not necessary the only element to be used to generate clapping force, as long as any mechanical means such as hydraulic means or springing means that is capable of generating clapping force may be applicable.

Whilst the clapper member has been described and illustrated in pairs, the present invention is also workable with the employment of only one clapper member or more than two clapper members as what is advantageous is that the present clapping device, utilizing a reciprocation mechanism to actuate the clapper members (20) to produce to and fro clapping force, is portable.

While the preferred embodiment of the present invention and their advantages have been disclosed in the above Detailed Description, the invention is not limited thereto but only by the spirit and scope of the appended claim.

1. A clapping device for effecting clapping force to a predetermined area of a person's body comprising;
at least a clapper member,
at least a reciprocation mechanism connected to said clapper member for controlling reciprocating motion of the said clapper member;
wherein,
the said reciprocation mechanism utilizes at least a clapping force generating element to actuate at least a clapper member into a to and fro mode,
the said reciprocation mechanism is housed in a reciprocation mechanism housing and in turn mounted to a portable main housing.

2. A clapping device for effecting clapping force to a pre-determined area of a person's body as in claim 1 wherein said clapping device is capable of being worn by the user.

3. A portable clapping device for effecting clapping force to a pre-determined area of a person's body as in claim 1 wherein the said clapping device is capable of being detachably attached to a structure.

4. A portable clapping device for effecting clapping force to a pre-determined area of a person's body as in claim 1 wherein said reciprocation mechanism is detachably attached to the main housing by attaching the reciprocation mechanism housing to at least a slot located at the central portion of the main housing by means of an attaching means.

5. A portable clapping device for effecting clapping force to a pre-determined area of a person's body as in claim 1 wherein the reciprocation mechanism housing is capable of being made to move up and down along the longitudinal axis of the main housing.

6. A portable clapping device for effecting clapping force to a pre-determined area of a person's body as in claim 5 wherein the up and down movement along the longitudinal axis is by way of having the gear integrated in the said reciprocation mechanism housing to complementarily contact a longitudinal slot of the central vertical portion having protrusions and depressions depicting tooth-like configuration when the reciprocation mechanism housing is attached to the central vertical portion.

7. A portable clapping device for effecting clapping force to a pre-determined area of a person's body as in claim 5 wherein the up and down movement along the longitudinal axis is by electronic or manual means.

8. A portable clapping device for effecting clapping force to a pre-determined area of a person's body as in claim 5 wherein the gear is driven by a motor to electronically rotate the said gear along the tooth-like configuration of the longitudinal slot thereby moving the reciprocation mechanism housing along the longitudinal axis of the main housing.

9. A portable clapping device for effecting clapping force to a pre-determined area of a person's body as in claim 3 wherein the said reciprocation mechanism housing is detachably attached to a structure by means of arm straps that are provided to the reciprocation housing for strapping onto the structure.

10. A portable clapping device for effecting clapping force to a pre-determined area of a person's body as in claim 3 wherein the said reciprocation mechanism housing is detachably attached to a structure by means of a clip that has a hinging means dividing the clip into two flap protions that are moveable and capable of locking when the two flap portions are brought to contact with the portion of the structure to be clipped.

11. A portable clapping device for effecting clapping force to a pre-determined area of a person's body as in claim 1 wherein said reciprocation mechanism housing enclosing the reciprocation mechanism is capable of being detachably attached to a hand-held holder.

12. A reciprocation mechanism as in any of the preceding claims comprising at least a clapping force generating element connected to a shaft to be rotably driven by a drive motor which acts on at least a support bar having at least a clapper member attached to its free end to generate pre-determined clapping force.

13. A clapping force generating element as in claim 12 which comprises at least a cam or mechanical means

14. A reciprocation mechanism as in claim 12 wherein an embodiment of the said reciprocation mechanism, a first reciprocation mechanism, comprises at least a first clapping force generating element and at least a support bar, said first clapping force generating element is connected to a shaft to be rotably driven by a drive motor to contact an aperture substantially situated at the central axis of one of the elongated support bar having its free end provided with clapper members to alternately actuate the first and second clapper member to generate clapping force with repeated cycles.

15. A reciprocation mechanism as in claim 12 wherein another embodiment of the said reciprocation mechanism, a second reciprocation mechanism, comprises at least a second clapping force generating element and at least a first and a second support bar wherein said second clapping force generating element attached to a first support bar moves in a circular motion when driven by a drive motor to tilt the first support bar to alternately move the first and second clapper member attached to the free end of the support bar to generate clapping force with repeated cycles.

16. A reciprocation mechanism as in claim 13, wherein a third clapping force generating element is attached to a second support bar and its clapper member has a body fitter or adjustor which allows the clapper members and support bars to be in substantial horizontal alignment clapping force.

17. A reciprocation mechanism as in claim 12 wherein another embodiment of the said reciprocation mechanism, a fourth reciprocation mechanism, comprising a fourth clapping force generating element and at least a first and second support bar a shaft and a drive motor; said fourth clapping force generating element is configured to have a wide and narrow side portions to form a lopped-sided clapping force generating element; wherein when the wide side portion comes into contact with the first support bar, the narrow side portion comes into close proximity with the second support bar and vice versa to generate clapping force with repeated cycles.

18. A reciprocation mechanism as in claim 12 wherein another embodiment of the said reciprocation mechanism, a fifth reciprocation mechanism comprising a fifth clapping force generating element, at least a plate, a plurality of support bars and at least a springing element; said fifth clapping force generating element consisting of at least two cams in overlapping arrangement connected to a shaft to be rotably driven by a drive motor to enable the cams to alternately contact and act on the support bars, a first cam to contact with a protrusion of the first support bar thereby depressing it which in turn tilts the first support bar attached with the first clapper member from its original non-activated position while the other cam not in contact with the second support bar will cause the second clapper member to remain in its original position and vice versa to generate clapping force with repeated cycles.

19. A reciprocation mechanism as in claim 12 wherein another embodiment of the said reciprocation mechanism, a sixth reciprocation mechanism comprising an elongated shaft driven by a drive motor provided with a gear component to control the speed of the drive motor and at least a pair of cams wherein one cam is caused to actuate the first clapper member alternately with another cam to actuate the second clapper member to generate clapping force with repeated cycles.

20. A portable clapping device for effecting clapping force to a pre-determined area of a person's body as in claim 1 wherein the movement of the clapper member to generate clapping force comprises a to and fro movement.

21. A portable clapping device for effecting clapping force to a pre-determined area of a person's body as in claim 1 wherein the movement of the clapper member to generate clapping force comprises any oscillating, up and down, forward and backward and left and right movement.

22. A portable clapping device for effecting clapping force to a pre-determined area of a person's body as in claim 1 wherein the clapper members are caused to move alternately in opposing directions to generate pre-determined clapping force.

23. A portable clapping device for effecting clapping force to a pre-determined area of a person's body as in claim 1 wherein the clapping device is capable of causing generation of resonance waves.

24. A portable clapping device for effecting clapping force to a pre-determined area of a person's body as in claim 1 wherein a body fitter or adjustor is provided to the clapper member.

25. A portable clapping device for effecting clapping force to a pre-determined area of a person's body as in claim 1 wherein the clapper members are provided with pre-determined perforations.

26. A method of generating clapping force to a pre-determined area of a person's body comprising steps of,
putting on a portable main housing provided with a reciprocation mechanism over a person or a structure;
activating a reciprocation mechanism causing rotation of a clapping force generating element which is connected to a shaft driven by a drive motor;
causing the contacting of said clapping force generating element with at least a support bar provided with at least a clapper member at its end to actuate support bar;
causing at least a clapper member to move from its original position.
